(19) United States
(12) Patent Application Publication
(10) Pub. No.: US 2005/0082980 A1
(43) Pub. Date: Apr. 21, 2005

(54) Plasma display panel

(76) Inventors: Young-mo Kim, Suwon-si (KR); Sang-hun Jang, Yongin-si (KR); Hidekazu Hatanaka, Seongnam-si (KR); Seung-hyun Son, Hwaseong-si (KR); Seong-eui Lee, Seongnam-si (KR); Gi-Young Kim, Chungiu-si (KR); Hyoung-bin Park, Seongnam-si (KR)

Correspondence Address: MCGUIREWOODS, LLP, 1750 TYSONS BLVD, SUITE 1800, MCLEAN, VA, 22102, US

(21) Appl. No.: 10/963,634

(22) Filed: Oct. 14, 2004

(30) Foreign Application Priority Data
Oct. 16, 2003 (KR) 2003-0072139

(51) Int. Cl. H01J 17/49

(52) U.S. Cl. 313/587

(57) ABSTRACT

A discharge gas for exciting fluorescent material to emit visible light and a plasma display panel including rear and front substrates facing each other to form a discharge space therebetween, where the discharge gas is in the discharge space and is a gaseous mixture of Ne gas, Xe gas and Kr gas, and the concentration of the Kr gas is in the range of 14-44%.

This application claims the benefit of Korean Patent Application No. 2003-72139, filed on Oct. 16, 2003, which is hereby incorporated by reference for all purposes as if fully set forth herein.

### BACKGROUND OF THE INVENTION

1. Field of the Invention

The present invention relates to a plasma display panel and a discharge gas for exciting fluorescent material to emit visible light, and more particularly to a plasma display panel with enhanced brightness and efficiency due to the composition of the discharge gas.

2. Discussion of the Related Art

Plasma display panels (PDPs), which form images using an electric discharge, are widely used due to their excellent performance characteristics such as brightness and wide viewing angles. In a PDP, a voltage is applied to its electrodes to generate a gas discharge, which causes ultraviolet light to excite fluorescent material, thereby creating visible light (i.e. the displayed image).

PDPs are categorized as either alternating current (AC) or direct current (DC) types. In a DC type PDP, all of the electrodes are exposed to a discharge space, and electric charges move directly between the corresponding electrodes. In an AC type, at least one electrode is covered by a dielectric layer, and the discharge is performed by a wall charge, not by a flow of electric charges between corresponding electrodes.

PDPs are further categorized into facing discharge and surface discharge types. In the facing discharge type, each pair of sustain electrodes is separately formed on a front substrate and a rear substrate, and the discharge occurs perpendicularly to the substrates. On the other hand, in the surface discharge type, each pair of sustain electrodes is formed on the same substrate, and the discharge occurs parallel to the substrate.

Facing discharge type PDPs have high luminous efficiency, but their fluorescent layer is likely to be deteriorated by plasmas. Therefore, surface discharge type PDPs have become the standard.

Penning gas, which comprises neon (Ne) gas mixed with a low concentration of xenon (Xe) gas, is typically used as a PDP discharge gas. The discharge gas typically emits ultraviolet light of about 147 nm. With Penning gas, increased concentration of Xe gas typically leads to a decrease of visible orange light created by the Ne gas, thereby intensifying color purity. But the corresponding decreased concentration of Ne gas causes a sharp increase in the discharge starting voltage. Therefore, it is difficult to appreciably improve the PDP color purity while staying within a practical driving voltage range.

### SUMMARY OF THE INVENTION

Accordingly, the present invention is directed to a discharge gas and a PDP that substantially obviates one or more of the problems due to limitations and disadvantages of the related art.

This invention provides a PDP with enhanced brightness and efficiency due to the composition of the discharge gas.

This invention further provides a discharge gas for exciting fluorescent material to emit visible light, wherein the discharge gas is a gaseous mixture of Ne gas, Xe gas, and Kr gas.

Additional features of the invention will be set forth in the description which follows, and in part will be apparent from the description, or may be learned by practice of the invention.

The present invention discloses a PDP including a rear and front substrate that face each other and form a discharge space therebetween, wherein a discharge gas in the discharge space is a gaseous mixture of Ne gas, Xe gas, and krypton (Kr) gas. It further discloses the concentration of the Kr gas to be in the range of about 14% to about 44%.

The present invention also discloses a PDP comprising a rear substrate and a front substrate which face each other and form a discharge space therebetween, with a plurality of address electrodes formed in the upper surface of the rear substrate. A first dielectric layer is formed on the upper surface of the rear substrate to cover the address electrodes. A plurality of partition walls are formed on the upper surface of the first dielectric layer to partition the discharge space, and a plurality of sustain electrodes formed in the lower surface of the front substrate. A second dielectric layer is formed on the lower surface of the front substrate to cover the sustain electrodes, and a protection layer is formed in the lower surface of the second dielectric layer. A fluorescent layer is coated on the upper surface of the first dielectric layer and on the sides of the partition walls, and a discharge gas is filled in the discharge space, wherein the discharge gas is a gaseous mixture of Ne gas, Xe gas, and Kr gas, and the concentration of the Kr gas is in the range of about 14% to about 44%.

The present invention also discloses a discharge gas for exciting fluorescent material to emit visible light, wherein the discharge gas is a gaseous mixture of Ne gas, Xe gas, and Kr gas. And the concentration of the Kr gas is in the range of about 14% to about 44%.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows an exploded perspective view of a surface discharge type PDP according to an exemplary embodiment of the present invention.

FIG. 2 shows a vertical section view of the inner structure of the surface discharge type PDP displayed in FIG. 1.

FIGS. 3A, 3B and 3C show graphs of a PDP's brightness in relation to sustain voltage when the concentration of Xe is about 9%, 17.5%, and 26%, respectively, and the concentrations of Kr and Ne are varied.

FIGS. 4A, 4B and 4C show graphs of a PDP's luminous efficiency in relation to the sustain voltage when the concentration of Xe is about 9%, 17.5%, and 26%, respectively, and the concentrations of Kr and Ne are varied.

### DETAILED DESCRIPTION OF THE ILLUSTRATED EMBODIMENTS

Reference will now be made in detail to an embodiment of the present invention, example of which is illustrated in the accompanying drawings.

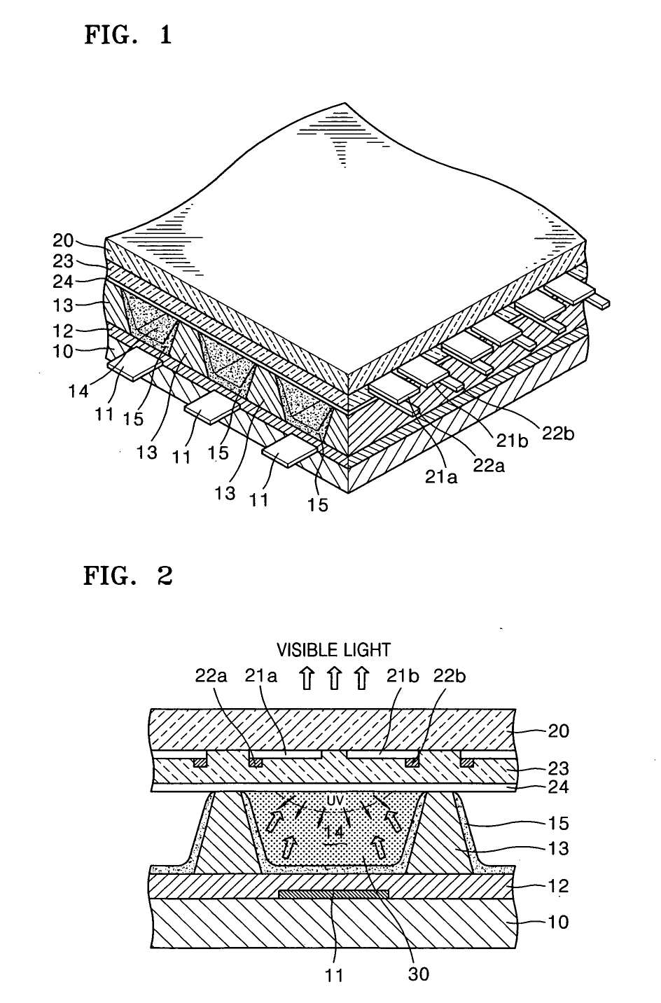

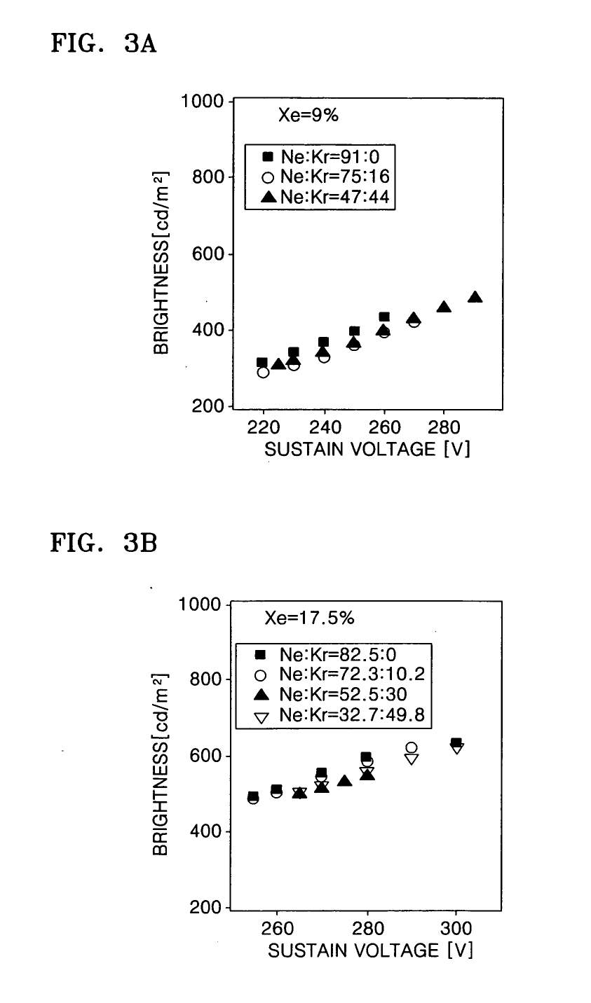

FIGS. 1 and 2 show a surface discharge type PDP according to an exemplary embodiment of the present invention. Referring to FIGS. 1 and 2, a rear substrate 10 and a front substrate 20, which are separated, face each other.

A plurality of address electrodes 11 are arranged in stripes on the upper surface of the rear substrate 10, and they are covered by a first dielectric layer 12. A plurality of partition walls 13 are formed, at a predetermined interval, on the upper surface of the first dielectric layer 12 to prevent electric and optical interference between discharge spaces 14. A fluorescent layer 15 of red (R), green (G), and blue (B) colors is coated with a predetermined thickness on the inner surfaces of the discharge spaces 14. A discharge gas 30, which emits ultraviolet light during a discharge, is injected into the discharge spaces 14. The discharge gas 30 is composed of a mixture of Ne gas, Xe gas and Kr gas.

The front substrate 20, which is transparent so that visible light can pass through it, is usually made of glass, and it is joined together with the rear substrate 10. Striped pairs of sustain electrodes 21a and 21b, which are orthogonal to the address electrodes 11, are formed on the lower surface of the front substrate 20. The sustain electrodes 21a and 21b are made of transparent conductive materials such as ITO (Indium Tin Oxide) that allow visible light to pass through them. Metallic bus electrodes 22a and 22b are formed on the lower surface of the sustain electrodes 21a and 21b with narrower widths than the sustain electrodes to reduce the sustain electrodes' resistance.

A transparent second dielectric layer 23 covers the sustain electrodes 21a and 21b and the bus electrodes 22a and 22b. A protection layer 24, typically made of MgO (magnesium oxide), is formed on the lower surface of the second dielectric layer 23 to protect the second dielectric layer 23 from being damaged by the sputtering of plasma particles and to emit second electrons to lower discharge and sustain voltages.

A PDP having the above configuration is driven by address and sustain discharges. A wall charge is formed on the second dielectric layer 23 when an address discharge occurs between the address electrodes 11 and one of the sustain electrodes 21a and 21b. A sustain discharge occurs by a potential difference between the sustain electrodes 21a and 21b. As the sustain discharge occurs, the discharge gas emits ultraviolet light to excite the fluorescent layer 15 of the corresponding discharge space 14, thereby producing visible light. This visible light penetrates through the front substrate 20 as an image that viewers can recognize.

In an exemplary embodiment of the present invention, the discharge gas comprises a gaseous mixture of Ne gas, Xe gas, and Kr gas. The concentrations, by volume, of the Kr gas and the Xe gas are in the range of about 14% to about 44% (about 16% is preferred) and about 10% to about 26%, respectively. The discharge gas 30 pressure in the discharge space 14 is about 60 KPa.

Both the Xe gas and the Kr gas emit ultraviolet light. The Xe gas emits ultraviolet light of a wavelength of 147 nm as an excited Xe* is stabilized. And the Kr gas emits ultraviolet light of a wavelength of 146 nm as an eximer Kr₂* is stabilized, where the eximer Kr₂* is generated by collisions among unstable Kr*, stable Kr and a third element. As described above, because the Xe gas and the Kr gas emit ultraviolet light of almost the same wavelength, a fluorescent material, which emits visible light when excited by ultraviolet light of a wavelength of 147 nm, can be used in an exemplary embodiment of the present invention, as in the conventional art.

As the Xe gas concentration increases in the gaseous mixture, Xe in a stable state is transformed into excited Xe* by absorbing ultraviolet light of 147 nm. This self-absorption of ultraviolet light decreases the PDP's efficiency because that ultraviolet light is not available to excite the fluorescent layer 15. On the other hand, as the Kr gas concentration increases, this promotes more frequent collisions, as described above, and more eximer Kr₂* is created, which means more ultraviolet light of 146 nm wavelength is emitted. However, stable state Kr is not transformed into eximer Kr₂* by absorbing ultraviolet light of 146 nm, even though the concentration of the Kr gas increases. Therefore, the Kr gas does not absorb the ultraviolet light it creates, which increases the PDP efficiency because more ultraviolet light arrives at the fluorescent layer 15 when there is little to no self-absorption.

The Ne gas creates visible orange light, which negatively impacts PDP color purity, when a discharge occurs. In an exemplary embodiment of the present invention, when the Kr gas concentration increases, the Ne gas concentration decreases correspondingly, which may improve color purity.

Also, since a Kr atom is heavier than an Ne atom, the discharge gas 30 according to an exemplary embodiment of the present invention may be heavier than a conventional discharge gas. Increased mass of the discharge gas 30 decreases, kinetic energy of gas particles. Therefore, the sputtering rate on the protection layer 24 may drop, which may extend the PDP's lifespan.

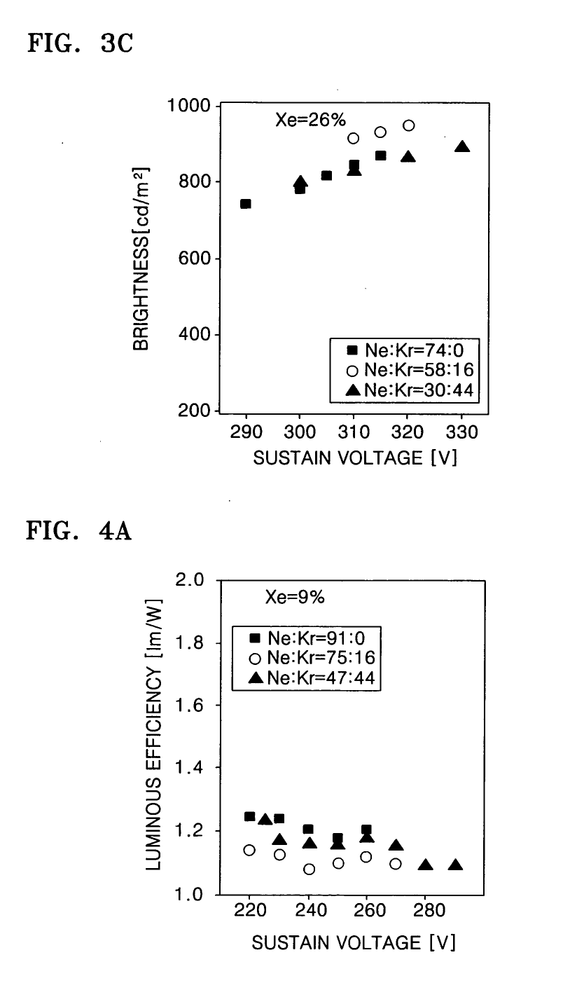

FIGS. 3A, 3B and 3C show graphs of a PDP's brightness in relation to sustain voltage when the concentration of Xe is about 9%, 17.5%, and 26%, respectively, and the concentrations of Kr and Ne are varied. These graphs display experimental results under experimental conditions in which the fluorescent layer 15 is excited by ultraviolet light of the wavelength of 147 nm, the pressure of the discharge gas is about 60 KPa, and the driving signal frequency and the duty cycle for maintaining the discharge are about 110 KHz and 10%, respectively.

FIG. 3A is a graph of brightness with respect to the sustain voltage when the Xe gas concentration is maintained at about 9%, and the Kr gas concentration is about 0%, 16%, and 44%, respectively. In this case, the brightness did not increase when the Kr gas concentration was increased above 0%.

FIG. 3B is a graph of brightness with respect to the sustain voltage when the Xe gas concentration is maintained at about 17.5%, and the Kr gas concentration is about 0%, 10.2%, 30% and 49.8%, respectively. In this case, like the result shown in FIG. 3A, the brightness did not increase when the Kr gas concentration was increased above 0%.

FIG. 3C is a graph of brightness with respect to the sustain voltage when the Xe gas concentration is maintained at about 26%, and the Kr gas concentration is about 0%, 16%, and 44%, respectively. In this case, the panel brightness was about 10% higher when the Kr gas concentration was about 16% than when the Kr gas concentration was about 0% or 44%.

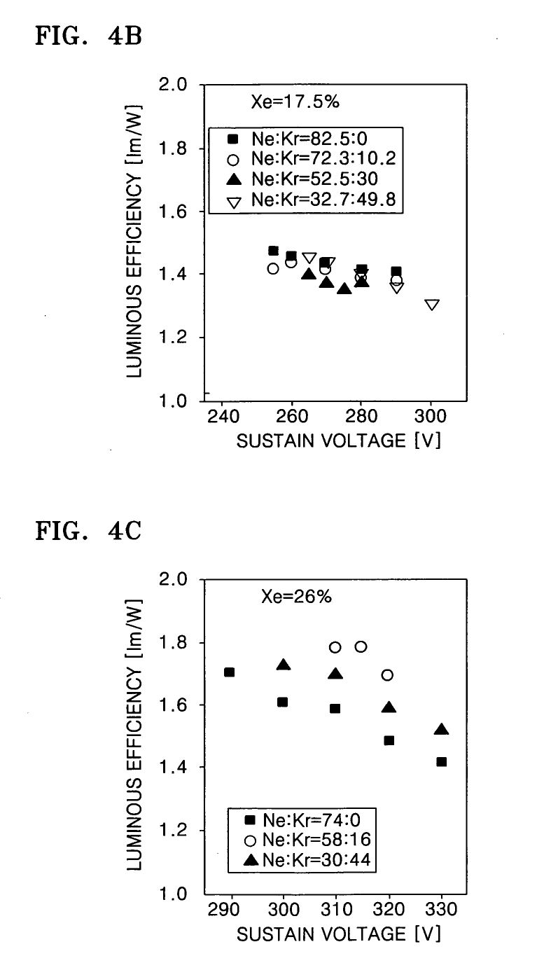

FIGS. 4A, 4B and 4C show graphs of a PDP's luminous efficiency in relation to the sustain voltage when the concentration of Xe is about 9%, 17.5%, and 26%, respectively, and the concentrations of Kr and Ne are varied. These graphs also display experimental results under experimental conditions in which the fluorescent layer 15 is excited by ultraviolet light of the wavelength of 147 nm, the pressure of the discharge gas is about 60 KPa, and the driving signal frequency and the duty cycle for maintaining the discharge are about 10 KHz and 10%, respectively.

FIG. 4A is a graph of luminous efficiency with respect to the sustain voltage when the Xe gas concentration is maintained at about 9%, and the Kr gas concentration is about 0%, 16%, and 44%, respectively. In this case, the luminous efficiency did not increase when the Kr gas concentration was increased above 0%.

FIG. 4B is a graph of luminous efficiency with respect to the sustain voltage when the Xe gas concentration is maintained at about 17.5%, and the Kr gas concentration is about 0%, 10.2%, 30% and 49.8%, respectively. In this case, like the result shown in FIG. 4A, the luminous efficiency did not increase when the Kr gas concentration was increased above 0%.

FIG. 4C is a graph of luminous efficiency with respect to the sustain voltage when the Xe gas concentration is maintained at about 26%, and the Kr gas concentration is about 0%, 16%, and 44%, respectively. In this case, the luminous efficiency of the panel was about 20% higher when the Kr gas concentration was about 16% than when the Kr gas concentration was about 0%, and the luminous efficiency of the panel was about 10% higher when the Kr gas concentration was about 44% than when the Kr gas concentration was about 0%.

As described above, PDP brightness and luminous efficiency may be enhanced, and its lifespan may be extended, when the gaseous mixture of Ne gas, Xe gas and Kr gas is used as the discharge gas, and the concentration of the Kr gas is in the range of about 14% to about 44%.

Thus, the PDP according to an exemplary embodiment of the present invention may improved the color purity, luminous efficiency and extend the PDP lifespan.

While an exemplary embodiment of the present invention has been described in relation to a PDP, the discharge gas of the present invention is not limited to use in a PDP or in a PDP as illustrated herein.

It will be apparent to those skilled in the art that various modifications and variation can be made in the present invention without departing from the spirit or scope of the invention. Thus, it is intended that the present invention cover the modifications and variations of this invention provided they come within the scope of the appended Claims and their equivalents.

1. A plasma display panel (PDP), comprising:
a rear substrate and a front substrate, combined together to form a discharge space therebetween; and
a discharge gas in the discharge space;
wherein the discharge gas is a gaseous mixture of Ne gas, Xe gas, and Kr gas and the concentration of the Kr gas is in the range of about 14% to about 44%.

2. The PDP of claim 1, wherein the concentration of the Xe gas is in the range of about 10% to about 26%.

3. The PDP of claim 1, wherein the concentration of the Kr gas is about 16%.

4. The PDP of claim 2, wherein the concentration of the Kr gas is about 16%.

5. The PDP of claim 1, wherein the pressure of the discharge gas in the discharge space is about 60 KPa.

6. The PDP of claim 2, wherein the pressure of the discharge gas in the discharge space is about 60 KPa.

7. A plasma display panel (PDP), comprising:
a rear substrate and a front substrate, combined together to form a discharge space therebetween;
a plurality of address electrodes formed on an upper surface of the rear substrate;
a first dielectric layer formed in the upper surface of the rear substrate to cover the address electrodes;
a plurality of partition walls formed on the first dielectric layer to partition the discharge space;
a plurality of sustain electrodes formed on a lower surface of the front substrate;
a second dielectric layer formed in the lower surface of the front substrate to cover the sustain electrodes;
a protection layer formed on the second dielectric layer;
a fluorescent layer coated on the first dielectric layer and on the sides of the partition walls; and
a discharge gas in the discharge space;
wherein the discharge gas is a gaseous mixture of Ne gas, Xe gas, and Kr gas, and the concentration of the Kr gas is in the range of about 14% to about 44%.

8. The PDP of claim 7, wherein the concentration of the Xe gas is in the range of about 10% to about 26%.

9. The PDP of claim 7, wherein the concentration of the Kr gas is about 16%.

10. The PDP of claim 8, wherein the concentration of the Kr gas is about 16%.

11. The PDP of claim 7, wherein the pressure of the discharge gas in the discharge space is about 60 KPa.

12. The PDP of claim 8, wherein the pressure of the discharge gas in the discharge space is about 60 KPa.

13. A discharge gas for exciting fluorescent material to emit visible light, comprising:
Ne gas;
Xe gas; and
Kr gas,
wherein the Kr gas concentration is in a range of about 14% to about 44%.

14. The discharge gas of claim 13, wherein the Xe gas concentration is in the range of about 10% to about 26%.

15. The discharge gas of claim 13, wherein the Kr gas concentration is about 16%.

16. The discharge gas of claim 14, wherein the Kr gas concentration is about 16%.

17. The discharge gas of claim 13, wherein the discharge gas is used at a pressure level of about 60 KPa.

18. The discharge gas of claim 14, wherein the discharge gas is used at a pressure level of about 60 KPa.
